(19) United States
(12) Patent Application Publication
(10) Pub. No.: US 2023/0364742 A1
(43) Pub. Date: Nov. 16, 2023

(54) ABRASIVE ARTICLES AND METHODS OF FORMING

(71) Applicants: SAINT-GOBAIN ABRASIVES, INC., Worcester, MA (US); SAINT-GOBAIN ABRASIFS, Conflans-Sainte-Honorine (FR)

(72) Inventors: Ji WANG, Shanghai (CN); Kelley MCNEAL, Northborough, MA (US); Jian XU, Shanghai (CN); Ji XIAO, Shanghai (CN); Aiyun LUO, Shanghai (CN); Cecile O. MEJEAN, Acton, MA (US)

(21) Appl. No.: 17/754,905

(22) PCT Filed: Oct. 16, 2020
(86) PCT No.: PCT/US2020/056111

§ 371 Date: Apr. 15, 2022

Related U.S. Application Data
(60) Provisional application No. 62/928,328, filed on Oct. 30, 2019.
(60) Provisional application No. 62/925,076, filed on Oct. 23, 2019.
(60) Provisional application No. 62/916,181, filed on Oct. 16, 2019.

(51) Int. Cl. B24D 3/08; B24D 18/00; C22C 26/00; C22C 38/24; C22C 38/22; C22C 38/04; C22C 38/02; C22C 38/00; B22F 10/14; B22F 10/62; B22F 10/64; B33Y 10/00; B33Y 40/20; B33Y 80/00

(52) U.S. Cl. CPC B24D 3/08; B24D 18/0072; C22C 26/00; C22C 38/24; C22C 38/22; C22C 38/04; C22C 38/02; C22C 38/002; B22F 10/14; B22F 10/62; B22F 10/64; B33Y 10/00; B33Y 40/20; B33Y 80/00; B22F 2998/10; B22F 2999/00; B22F 2302/406; B22F 2301/35; B22F 2005/001

(57) ABSTRACT

An abrasive particle can include a body including abrasive particles contained in a bond matrix. The bond matrix can include a first phase and a second phase. In an embodiment, the body can have a Microstructure Feature of greater than 1 and a Non-Bond Value of not greater than 50%. In another embodiment, the body can include a Microstructure Feature including a Spacing Value of at least 0.01.

### TECHNICAL FIELD

The present invention relates, in general, to abrasive articles including abrasive particles contained in a bond material and methods of forming the same.

### BACKGROUND ART

Abrasive articles are used in material removal operations, such as grinding, cutting, or shaping various materials. Pencil edge wheels are used in grinding operations of automotive glass and are specifically designed to match the glass thickness. Conventionally, pencil edge wheels are formed by hot pressing a mixture of a metal bond and diamond particles to form a wheel body and then using Electro-Discharge Machining (EDM) to create the specific profile. Surfaces of the wheel body are often ground prior to the EDM process.

Core drill bits are used in glass drilling applications. Due to the nature of glass and lack of better control over the formation of holes, chipped areas are often formed around edges of drilled holes. Moreover, glass core drill bits are worn out quickly and often have reduced service life.

The industry continues to demand improved abrasive articles.

### BRIEF DESCRIPTION OF THE DRAWINGS

The present disclosure may be better understood, and its numerous features and advantages made apparent to those skilled in the art by referencing the accompanying drawings.

FIG. 1 includes a flow chart illustrating a process of forming an abrasive article according to an embodiment.

FIG. 2 includes an SEM image of a portion of a cross section of a body of a fixed abrasive article according to an embodiment.

FIGS. 3A to 3E include images of a portion of a cross section of a bonded abrasive body in accordance with an embodiment.

FIGS. 4A to 4D include images of a portion of a cross section of a bonded abrasive body formed by hot pressing. 30 FIGS. 5A to 5C include images of a portion of a cross section of a bonded abrasive body in accordance with an embodiment.

FIGS. 5D to 5F include images of a portion of a cross section of another bonded abrasive body in accordance with an embodiment.

FIG. 5G includes a plot of layer thickness vs. Spacing Value of different abrasive bodies.

FIG. 6A and FIG. 6B include illustrations of cross sections of abrasive articles in accordance with embodiments.

FIG. 7 includes an illustration of a side view of a core drill bit in accordance with an embodiment.

FIGS. 8A to 8C include images of cross sections abrasive samples formed under different conditions.

FIG. 8D includes a plot of percentage of effective infiltration vs. Non-Bond Value of the abrasive samples of FIGS. 8A to 8C.

FIG. 9A includes an illustration of wear of abrasive samples.

FIG. 9B includes an illustration of G-Ratio of abrasive samples.

FIGS. 10A and 10B include SEM images of cross sections of bonded abrasive bodies.

FIG. 11A includes an illustration of a portion of a body of an abrasive article according to an embodiment.

FIG. 11B includes an image of a bonded abrasive body.

FIG. 11C includes an illustration of a portion of a body of an abrasive article according to another embodiment.

FIG. 11D includes an image of a bonded abrasive body.

FIG. 12 includes a photo of abrasive articles.

FIG. 13 includes a plot of number of drilled holes vs. wear of abrasive articles.

FIG. 14A includes an illustration of a cross section of a portion of an abrasive body according to an embodiment.

FIG. 14B includes an illustration of a cross section of a portion of an abrasive body according to another embodiment.

FIG. 14C includes an illustration of a front view of a working surface of an abrasive body.

FIG. 15 includes a graph including wear rates of abrasive samples.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION OF THE PREFERRED EMBODIMENT(S)

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single embodiment is described herein, more than one embodiment may be used in place of a single embodiment. Similarly, where more than one embodiment is described herein, a single embodiment may be substituted for that more than one embodiment.

Unless otherwise defined, all technical and scientific terms used herein have the same meaning as commonly understood by one of ordinary skill in the art to which this invention belongs. The materials, methods, and examples are illustrative only and not intended to be limiting. To the extent that certain details regarding specific materials and processing acts are not described, such details may include conventional approaches, which may be found in reference books and other sources within the manufacturing arts.

Embodiments are directed to a process of forming abrasive articles. The process can include utilizing additive manufacturing to form a green body and treating the green body, such as with heat, to form a finally formed body of the abrasive article. The process can allow improved control over formation of the abrasive articles, which can facilitate formation of abrasive articles having improved performance and/or properties.

Further embodiments are drawn to abrasive articles having microstructures that are distinct from those formed by using conventional pressing techniques, such as hot pressing, cold pressing, and/or warm pressing. The abrasive articles can have improved microstructures, which can facilitate improved performance and/or properties of the abrasive articles.

In an embodiment, the abrasive article can include fixed abrasive articles, including such as, bonded abrasive articles including an organic bond, vitrified bond, or a metal bond, and coated abrasive articles. A particular example of the fixed abrasive articles can include abrasive segments, cutting wheels, grinding stones, grinding wheels, core drill bits, and pencil edge wheels (also known to as “U-wheels”).

FIG. 1 includes an illustration of a process for forming an abrasive article. The process can start at block 101, forming a green body including a bond material and/or a bond precursor material and abrasive particles contained in the bond material and/or bond precursor material.

In an embodiment, the bond and/or bond precursor material may include metal, such as a powder metal material, or a precursor to a metal material, suitable for formation of a metal bond matrix material during further processing. Exemplary metal can include an elemental metal, metal alloy, or any combination thereof. In a particular example, metal can include a transition metal element, such as an element selected from Groups 4 to 12 of the periodic table published by IUPAC on Nov. 28, 2016, a metal other than a transition metal, such as a post-transition metal, another metal element, or any combination thereof. In another example, the bond and/or bond precursor material can include at least one Group 13, Group 14 element, a Group 15 element, or any combination thereof. Another particular example of metal can include iron, tungsten, cobalt, nickel, chromium, titanium, silver, tin, zinc, copper, manganese, aluminum, zirconium, niobium, tantalum, vanadium, molybdenum, palladium, gold, cadmium, indium, or a combination thereof.

In another particular example, the bond and/or bond precursor material can include an alloy including any of the metal elements noted in embodiments herein. For instance, an exemplary alloy can include iron, such as an iron-based alloy. In instances, alloy may include a non-metal element, such as carbon, silicon, sulfur, phosphorus, or any combination thereof. In another example, an iron-based alloy can include carbon, chromium, manganese, silicon, vanadium, molybdenum, tungsten, or any combination thereof. In a more particular implementation, an iron based alloy can include at least 80 wt % of iron, 2 wt % to 5 wt % of chromium, 1 wt % to 3 wt % of vanadium, 2 wt % to 8 wt % of tungsten, and 2 wt % to 7 wt % of molybdenum.

In an embodiment, the bond material and/or bond precursor material can be in the form of powder having a particular average particle size (D50) that can facilitate improved formation of the abrasive articles. For example, the average particle size of the bond material and/or bond precursor material can be at least 5 microns, such as at least 10 microns, at least 15 microns, at least 20 microns, at least 25 microns, at least 30 microns, at least 35 microns, at least 40 microns, at least 44 microns, at least 47 microns, at least 50 microns, at least 55 microns, at least 60 microns, at least 65 microns, at least 70 microns, at least 75 microns, at least 80 microns, at least 85 microns, at least 90 microns, or at least 100 microns. In another instance, the average particle size of the bond material and/or bond precursor material can be at most 300 microns, such as at most 250 microns, at most 200 microns, at most 160 microns, at most 140 microns, at most 120 microns, at most 100 microns, at most 90 microns, at most 85 microns, at most 80 microns, at most 70 microns, at most 65 microns, at most 60 microns, at most 55 microns, or at most 50 microns. Moreover, the average particle size of the bond material and/or bond precursor material can be in a range including any of the minimum and maximum values noted herein.

An example of the abrasive particles can include a material selected from the group consisting of oxides, carbides, nitrides, borides, diamond, or any combination thereof. Another example of abrasive particles can include a superabrasive material, such as diamond, cubic boron nitride (cBN), or any combination thereof. In a particular example, the abrasive particles can consist essentially of one or more superabrasive materials. For instance, the abrasive particles can consist essentially of diamond, cubic boron nitride (cBN), or any combination thereof. In a more particular implementation, the abrasive particles can consist of diamond. In another particular instance, the abrasive particles can include alumina, silicon carbide, boron nitride, or any combination thereof. In yet another example, the abrasive particles can have a Mohs hardness or at least 7, such as at least 8, or even at least 9. In further examples, the abrasive particles can non-shaped abrasive particles, shaped abrasive particles, or any combination thereof.

In an embodiment, the abrasive particles can have a particular average particle size that can facilitate improved formation of the abrasive articles. For example, the average particle size (D50) can be at least 0.1 microns, such as at least 0.2 microns, at least 0.5 microns, at least 0.8 microns, at least 1 micron, at least 2 microns, at least 3 microns, at least 4 microns, at least 5 microns, at least 6 microns, at least 8 microns, at least 10 microns, at least 15 microns, at least 20 microns, at least 25 microns, at least 30 microns, at least 35 microns, at least 40 microns, at least 45 microns, at least 50 microns, at least 55 microns, at least 60 microns, at least 70 microns, at least 80 microns, at least 85 microns, at least 95 microns, at least 100 microns, at least 125 microns, at least 140 microns, at least 150 microns, at least 170 microns, at least 200 microns, at least 220 microns, at least 250 microns, at least 280 microns, at least 300 microns, at least 330 microns, at least 350 microns, at least 370 microns, or at least 400 microns. In another example, the abrasive particles can have an average particle size of at most 2 mm, such as at most 1.5 mm, at most 1 3 mm, at most 1 mm, at most 900 microns, at most 800 microns, at most 700 microns, at most 600 microns, at most 550 microns, at most 500 micron, at most 470 microns, at most 450 microns, at most 430 micron, at most 400 microns, at most 370 microns, at most 350 microns, at most 300 microns, at most 280 microns, at most 240 microns, at most 200 microns, at most 130 microns, at most 150 microns, at most 145 microns, at most 120 microns, at most 110 microns, at most 105 microns, at most 100 microns, at most 95 microns, at most 90 microns, at most 85 microns, at most 80 microns, at most 75 microns, at most 70 microns, at most 65 microns, at most 60 microns, at most 50 microns, at most 45 microns, at most 40 microns. It is to be appreciated that the abrasive particles can have an average particle size within a range including any of the minimum and maximum values disclosed herein. For instance, the average particle size of the abrasive particles can be within a range including at least 0.1 microns and at most 2 mm or within a range including at least 25 microns and at most 400 microns or within a range including at least 100 microns to at most 400 microns or within a range including at least 30 microns and at most 150 microns or within a range including at least 200 microns to 400 microns or within a range including 300 microns to 400 microns.

In an embodiment, forming the green body can include an additive manufacturing process. For example, the additive manufacturing process can include selective laser sintering, binder jetting, stereolithography, direct metal laser sintering, electron beam melting, concept laser cusing, selective laser melting, laser powder injection, laser engineered net shaping, direct metal deposition, laser consolidation, free form fabrication, electron beam free form fabrication, plasma transferred arc-selective free form fabrication, ion fusion formation, shaped metal deposition, ultrasonic additive manufacturing, or any combination thereof. In a particular embodiment, forming the green body can include a binder jetting process. For instance, a binder jetting 3D printer or the like can be used to form the green body.

In an aspect, forming the green body can include forming a first layer including the bond and/or bond precursor material and abrasive particles. The first layer can further include a binder. In an exemplary implementation, the bond and/or bond precursor material, such as a stainless steel material, can be deposited in a powder bed. The abrasive particles can be deposited in the powder bed. In particular instances, depositing the abrasive particles includes a controlled deposition process including control of at least one parameter selected from the group of position of the abrasive particle, size of the abrasive particle, shape of the abrasive particle, composition of the abrasive particle, orientation of the abrasive particle or any combination thereof. In some implementations, a binder can be deposited in the powder bed after deposition of the abrasive particles. In particular instances, deposition of the binder on the powder bed can be selective to bind the component materials in contact with the binder.

In some implementations, a binder can be applied by e.g., a nozzle, to the first layer when the layer is printed to facilitate bonding between particles. In particular instances, the binder may be applied to certain portions of the first layer to facilitate selective binding of particles within the first layer or selective binding of a portion of the first layer to a subsequently formed layer.

In an example, the first layer can have a thickness that can facilitate improved formation of the green body and the abrasive articles. For example, the first layers may have a thickness of at least 30 microns, such as at least 50 microns, at least 70 microns, at least 90 microns, at least 100 microns, at least 120 microns, at least 140 microns, at least 160 microns, at least 180 microns, at least 200 microns, at least 240 microns, at least 260 microns, at least 300 microns, at least 350 microns, at least 380 microns, at least 400 microns, at least 420 microns, at least 440 microns, at least 460 microns, at least 480 microns, at least 500 microns, at least 510 microns, at least 530 microns, at least 550 microns, at least 570 microns, at least 600 microns, at least 620 microns, at least 630 microns, at least 650 microns, at least 680 microns, at least 700 microns, at least 720 microns, at least 740 microns, at least 760 microns, at least 780 microns, or at least 800 microns. In another instance, the thickness can be at most 2000 microns, at most 1800 microns, at most 1500 microns, at most 1200 microns, at most 1000 microns, at most 800 microns, at most 780 microns, at most 770 microns, at most 750 microns, at most 730 microns, at most 710 microns, at most 700 microns, at most 680 microns, at most 650 microns, at most 630 microns, at most 610 microns, at most 600 microns, at most 580 microns, at most 550 microns, at most 540 microns, at most 510 microns, at most 500 microns, at most 480 microns, at most 550 microns, at most 530 microns, at most 510 microns, at most 500 microns, at most 480 microns, at most 450 microns, at most 430 microns, at most 410 microns, at most 400 microns, at most 380 microns, at most 350 microns, at most 340 microns, at most 310 microns, at most 300 microns, at most 280 microns, at most 270 microns, at most 250 microns, at most 230 microns, at most 210 microns, at most 200 microns, at most 180 microns, at most 160 microns, at most 140 microns, at most 120 microns, at most 110 microns, at most 100 microns, at most 90 microns, at most 80 microns, at most 60 microns, or at most 50 microns. Moreover, the first layer can have a thickness in a range from 30 microns to 1000 microns or in a range from 40 microns to 600 microns or in a range from 70 microns to 500 microns or in a range from 80 microns to 400 microns.

In a further aspect, a second layer can be formed overlying at least a portion of the first layer. The second layer can include the bond and/or bond precursor material, abrasive particles, and the binder. The second layer can bind to the first layer via the binder.

In a further aspect, additional layers can be formed including the bond and/or bond precursor material, abrasive particles, and the binder in a similar manner to embodiments described with respect to the first layer and the second layer. Each of the layers can have any thickness as noted with respect to the first layer. In exemplary implementations, all the printed layers can have the same thickness. In an instance, the layers can have different thickness. In a further aspect, the layers can bind to one another via the binder to form the green body. In an exemplary implementation, the green body can be contained in a bed of unbound powder. The process can further include removing the unbound powder and extracting the green body.

In a particular aspect, forming the green body can include selectively binding portions of a plurality of layers to form the green body. In implementations, selectively binding can include at least one process from the group of selective deposition of a binder, curing, heating, irradiating, drying, or any combination thereof.

In a particular implementation, selectively binding includes forming a first layer of unbound powder including the bond precursor material and abrasive particles; selectively depositing a binder in portions of the first layer, wherein after selectively depositing the binder, the first layer includes unbound regions and bound regions, wherein the bound regions include the binder; forming a second layer of unbound powder overlying the first layer, wherein the second layer includes the bond precursor material and abrasive particles; and selectively depositing a binder in portions of the second layer, wherein after selectively depositing the binder, the second layer includes unbound regions and bound regions, wherein the bound regions include the binder.

In a further embodiment, the green body can include a porosity of at least 30 vol % for the total volume of the first precursor body. In some instances, the porosity can be at least 40 vol %, at least 45 vol % or at least 50 vol %. In another instance, the porosity of the green body may not be greater than 60 vol %, such as not greater than 55 vol % or not greater than 50 vol %. It is to be understood the porosity of the green body can be in a range including any of the minimum and maximum percentages noted herein, such as in a range from 30 vol % to 60 vol %.

In a further embodiment, the green body can include a content of the bond and/or bond precursor material (VB1) for the total volume of the bond and/or bond precursor material and abrasive particles (e.g., the solid volume of the green body), and include a content of abrasive particles (VAP) for the solid volume. In a further embodiment, the green body further can include a particular ratio (VB1/VAP) that can facilitate improved formation and performance of the abrasive articles. For example, the ratio (VB1/VAP) may be not greater than 8, such as not greater than 7, not greater than 6 or not greater than 5. In another instance, the ratio (VB1/VAP) can be at least 2, such as at least 3, at least 4, or at least 5. It is to be understood that the ratio (VB1/VAP) can be in a range including any of the minimum and maximum values noted herein, such as in a range from 2 to 8.

In another embodiment, the green body can include from 20 vol % to 70 vol % of the bond and/or bond precursor material for the total volume of the green body, and from 2 vol % to 50 vol % of abrasive particles for the total volume of the green body.

In a further embodiment, the green body can optionally include a filler material, including such as silicon carbide, tungsten carbide, Al₂O₃, or any combination thereof. In a further example, filler can include graphite. Filler can be in the form of powder, granules, particles, or a combination thereof. Filler may or may not be present in the finally-formed abrasive article. In an aspect, the green body can include up to 30 vol % of the filler material for the total volume of the green body.

The process can continue at block 102, to treat the green body to form a bonded abrasive body. In an embodiment, treating can include infiltrating the green body with an infiltrant material. In an aspect, the infiltrant material can include metal including, for example, at least one of a transition metal element, a Group 2 element, a Group 13 element, a Group 14 element, a Group 15 element, or any combination thereof. An example of infiltrant can include a metal including at least one of copper, tin, iron, chromium, tungsten, molybdenum, vanadium, silver, titanium, magnesium, cobalt, nickel, zinc, or any combination thereof. A further example of infiltrant can include an alloy including, for example, a silver-based alloy, such as AgCu, AgCuMn, AgCuZn, AgCuTi, AgCuIn, or AgTi, a copper-based alloy, such as bronze or brass, an iron-based alloy, such as FeCuCr or FeCuCrSn, an aluminum-based alloy, such as AlCuSi or AlCuSiSn, a brazing alloy, such as NiCr, or an alloy including at least one of Cu, Ag, Sn, and Ti, or any combination thereof.

In an exemplary implementation, the infiltrant can include a copper-tin bronze, a copper-tin-zinc alloy, or any combination thereof. Particularly, the copper-tin bronze may include a tin content not greater than 20 wt. %, such as not greater than 15 wt. % or not greater than 10 wt. %. In some instance, the copper-bronze may not include tin. Further, the tin content in the copper-tin bronze may be at least 1 wt. %, such as at least 3 wt. %. Similarly, the copper-tin-zinc alloy may include a tin content of not greater than 20 wt %, such as not greater than 15 wt % or lower. Moreover, the tin content in the copper-tin-zinc alloy may be at least 1 wt. %, such as at least 3 wt. %. The copper-tin-zinc alloy may include a zinc content not greater than 2 wt %, such as not greater than 1 wt. %. The zinc content in the copper-tin-zinc alloy can be at least 0.5 wt. %, such as at least 2 wt. %.

In a particular aspect, the infiltrant can have lower melting point compared to the bond and/or bond precursor material. For instance, the infiltrant material can have a melting point that may not be greater than 80% of the melting point of the bond and/or bond precursor material, such as not greater than 75% or not greater than 70% or not greater than 65% or not greater than 50% of the melting point of the bond and/or bond precursor material.

In a further aspect, infiltrating the green body may be conducted simultaneously with sintering of the green body and transforming the bond precursor material to a bond material.

In another aspect, infiltrating can be conducted in a non-oxidizing atmosphere. In a further aspect, infiltrating can be performed in a reducing atmosphere, an inert atmosphere, or an ambient atmosphere. Typically, reducing atmosphere can contain an amount of hydrogen to react with oxygen.

In a further aspect, infiltrating can be conducted at the melting temperature of the infiltrant. In another aspect, infiltrating can be conducted at a particular temperature that can facilitate improved formation and properties and performance of the abrasive article. For instance, infiltrating can be performed at a temperature of at least 900° C., such as at least 920° C., at least 940° C., at least 950° C., at least 970° C., at least 990° C., at least 1000° C., at least 1100° C., at least 1100° C., or at least 1200° C. In another instance, infiltrating can be performed at a temperature of at most of 1200° C., such as at most of 1150° C., at most of 1130° C., at most of 1100° C., at most 1050° C., at most of 1000° C., at most 990° C., at most of 970° C., at most 950° C., at most of 930° C., at most 910° C. or at most 900° C. Moreover, infiltrating can be performed at a temperature within a range including any of the minimum and maximum temperatures noted herein.

In an aspect, infiltrant can be placed adjacent the green body, such as in contact with a least a portion of the green body. In a particular aspect, a solid infiltrant can be placed in direct contact with at least a portion of the green body and heat can be applied to the body, the infiltrant, or both. In a further aspect, infiltrating can be carried out in a furnace, such as a batch furnace or a tunnel furnace. In a particular implementation, infiltrating can be performed in a tunnel furnace. In a further aspect, infiltrating can be conducted for a duration from 30 minutes to 120 minutes.

In a particular aspect, a bonded abrasive body can be formed after infiltration is completed. The abrasive body can include a bond material and abrasive particles. The infiltrant can bond the bond material and the abrasive grains together. For instance, the bond material and the infiltrant material can form the bond matrix of and at least a majority of the abrasive articles can be contained in the bond matrix and form a bonded abrasive body.

In a further aspect, the process can further include attaching the finally formed abrasive body to a core, such as a hub, or a shaft. In a particular instance, attaching can be performed simultaneously with infiltrating the green body. For instance, the abrasive body can be attached to the hub via the infiltrant and infiltrating process. In an aspect, the hub can include a central opening and the body can be attached to at least one surface of the hub. In particular implementations, the hub can include a peripheral groove and the body is contained at least partially within the peripheral groove. Alternatively, attaching can be performed by sintering, brazing, welding, or the like.

In a further aspect, the process can include conducting at least one treatment process prior to infiltrating the green body, wherein the at least one treatment process is selected from the group of heating, drying, volatilizing, cooling, freezing, or any combination thereof.

The bonded abrasive body can be a body of an abrasive segment, a continuous rim, a grinding wheel, an abrasive component of a core drill bit or pencil edge wheel, or an abrasive portion of another fixed abrasive article.

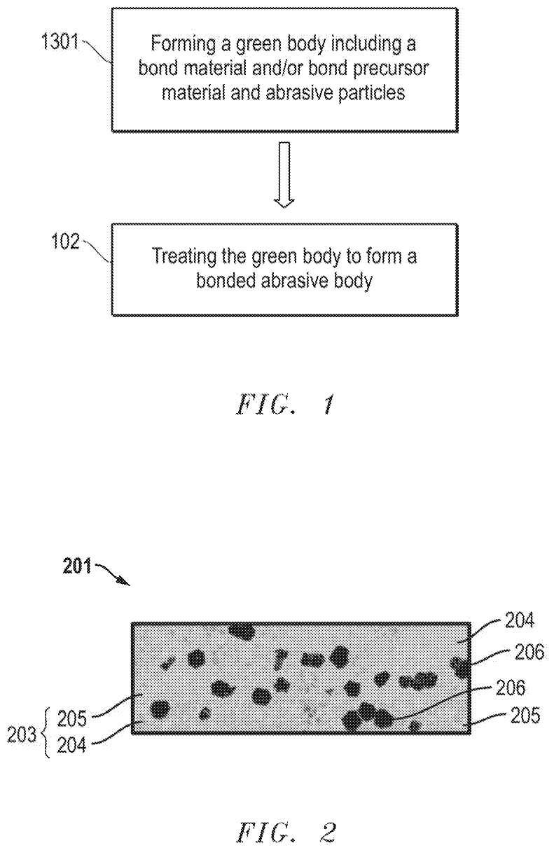

FIG. 2 includes an SEM image of a portion of a cross section of a bonded abrasive body 201 of an abrasive article. The body 201 includes a bond matrix 203 including a first phase 204 and a second phase 205 and abrasive particles 206 contained in the bond matrix 203. The first phase 204 can include any of the bond materials described in embodiments herein. Particularly, the first phase can consist essentially of the bond material. The second phase can include any of the infiltrant described in embodiments herein, and particularly, the second phase can consist essentially of the infiltrant. In a particular instance, the first phase can include metal, such as an iron-based alloy, and the second phase can include metal, such as bronze.

In an aspect, the body 201 can include a content of the first phase 204 of at least 15 vol %, such as at least 20 vol %, at least 30 vol %, at least 40 vol %, or at least 50 vol % for the total volume of the body. In another instance, the body may include not greater than 70 vol % of the first phase for a total volume of the body, such as not greater than 65 vol %, not greater than 60 vol %, not greater than 50 vol %, or not greater than 45 vol % for a total volume of the body. Moreover, the content of the first phase 204 can be in a range including any of the minimum and maximum percentages noted herein. In another aspect, the first phase 204 can form an interconnected phase. In a further aspect, the first phase 204 can define an interconnected phase extending through at least a portion of the body 201. In a particular aspect, the first phase 204 can extend through a majority of the volume of the body 201.

In a further aspect, the body 201 can include a content of the second phase 205 of at least 20 vol %, such as at least 30 vol %, at least 40 vol %, at least 50 vol %, or at least 60 vol % for the total volume of the body. In another instance, the body 201 may include not greater than 80 vol % of the second phase 205 for a total volume of the body, such as not greater than 75 vol %, not greater than 70 vol %, not greater than 65 vol %, not greater than 60 vol %, or not greater than 50 vol for a total volume of the body. Moreover, the content of the second phase 205 can be in a range including any of the minimum and maximum percentages noted herein. In another aspect, the second phase 205 can form an interconnected phase. In a further aspect, the second phase 205 can define an interconnected phase extending through at least a portion of the body 201. In a particular aspect, the second phase 205 can extend through at least a majority of the volume of the body 201.

In another aspect, the body 201 can include a particular content of the bond material that can facilitate improved formation and properties and/or performance of an abrasive article. For instance, the content of the bond material can be at least 15 vol % for a total volume of the body 201, such as, at least 18 vol %, at least 20 vol %, at least 25 vol %, at least 27.5 vol %, at least 35 vol %, at least 40 vol %, or at least 50 vol % for the total volume of the body 201. In another instance, the body 201 can include the content of the bond material of at most 70 vol % for a total volume of the body 201, such as at most 65 vol %, at most 60 vol %, at most 55 vol %, at most 52 vol %, at most 48 vol %, or at most 40 vol %. Moreover, the body can include the bond material in a content including the minimum and maximum percentages included herein.

In an embodiment, the body 201 can include a certain content of abrasive particles 206 that can facilitate improved formation and improved property and/or performance of the abrasive article. For instance, abrasive particles 206 can be present in a content of at least 1 vol % for a total volume of the body 201, such as at least 2 vol %, at least 5 vol %, at least 8 vol %, at least 12 vol %, at least 18 vol %, at least 21 vol %, at least 27 vol %, at least 33 vol %, at least 37 vol %, or at least 42 vol %. In another example, abrasive particles can be present in an amount of at most 50 vol %, such as at most 42 vol %, at most 38 vol %, at most 33 vol %, at most 28 vol %, or at most 25 vol %. Abrasive particles can be present in the body 201 in a content including any of the minimum and maximum percentages disclosed herein. For instance, abrasive particles 206 can be in a content from 2 vol % to 50 vol % for a total volume of the body 201. Additionally, the content of abrasive particles may be adjusted to suit particular applications. For example, an abrasive segment of a grinding or polishing tool can include from 3.75 vol % to 50 vol % abrasive particles for the total volume of the segment body. An abrasive component of a cutting tool can include from 2 vol % and 6.25 vol % abrasive particles for the total volume of the component body. An abrasive component for core drilling can include from 5 vol % and 20 vol % abrasive particles for the total volume of the component body.

In an embodiment, the bond material can include a particular composition that can facilitate improved performance and/or properties of the abrasive article. In an aspect, the bond material can be iron based. In another aspect, the bond material can include greater than 50 wt % of Fe for the total weight of the bond material, such as at least 60 wt % of Fe, at least 70 wt % of Fe, or at least 80 wt % Fe for a total weight of the bond material. In another aspect, the bond material can include at most 95 wt % of Fe, at most 90 wt %, at most 88 wt % or at most 85 wt % of Fe for a total weight of the bond material. Moreover, the bond material can include Fe in a content including any of the minimum and maximum percentages noted herein.

In a further aspect, the bond material can include vanadium. For example, the bond material can include at least 0.5 wt % of vanadium for a total weight of the bond material, such as at least 0.8 wt %, at least lwt %, at least 1.2 wt %, at least 1.5 wt %, or at least 1.8 wt % for a total weight of the bond material. In another instance, the bond material can include at most 10 wt % of vanadium for a total weight of the bond material, such as at most 9 wt %, at most 8 wt %, at most 7 wt %, at most 6 wt %, at most 5 wt %, at most 3 wt %, or at most 2 wt % of vanadium for a total weigh to of the bond material. Moreover, the content of vanadium in the bond material can be in a range including any of the minimum and maximum percentages noted herein.

In a further aspect, the bond material can include tungsten. In another aspect, tungsten can be in a content of at least 1 wt %, such as at least 2 wt %, at least 3 wt %, at least 4 wt %, at least 5 wt %, at least 6 wt % for a total weight of the bond material. In another aspect, the bond material can include tungsten in a content of at most 20 wt %, at most 18 wt %, at most 16 wt %, at most 15 wt %, at most 12 wt %, at most 10 wt %, 9 wt %, at most 8 wt %, or at most 7 wt % for a total weight of the bond material. Moreover, the bond material can include tungsten in a content in a range including any of minimum and maximum percentages noted herein.

In a further aspect, the bond material can include chromium. In another aspect, chromium can be in a content of at most 11 wt % for at total weight of the bond material, such as at most 10 wt %, at most 9 wt %, at most 8 wt %, at most 7 wt %, at most 6 wt %, or at most 5 wt % for at total weight of the bond material. In another aspect, the bond material can include chromium in a content of at least 1 wt %, such as at least 2 wt %, at least 3 wt %, or at least 4 wt % for at total weight of the bond material. Moreover, the bond material can include chromium in a content in a range including any of minimum and maximum percentages noted herein.

In a further aspect, the bond material can include molybdenum in a content of at most wt % for at total weight of the bond material, such as at most 12 wt %, at most 10 wt %, at most 9 wt %, at most 8 wt %, at most 7 wt %, or at most 6 wt % for at total weight of the bond material. In another aspect, the bond material can include molybdenum in a content of at least 1 wt % for the total weight of the bond material, such as at least 2 wt %, at least 3 wt %, at least 4 wt %, or at least 5 wt % for at total weight of the bond material. Moreover, the bond material can include molybdenum in a content in a range including any of minimum and maximum percentages noted herein.

In an embodiment, the body 201 can include a certain content of infiltrant that can facilitate improved formation and improved property and/or performance of the abrasive article. For instance, the body 201 can include at least 20 vol % of the infiltrant for the total volume of the body, such as at least 25 vol %, at least 30 vol %, at least 35 vol %, or at least 40 vol % of the infiltrant material. In another instance, the body 201 can include at most 70 vol % of the infiltrant material for the total volume of the body 201, such as at most 65 vol %, at most 60 vol %, at most 55 vol %, or at most 50 vol % of the infiltrant material. It is to be understood that the body 201 can include the infiltrant material in a content including any of the minimum and maximum percentages disclosed herein. For example, the body of an abrasive component can include the infiltrant material in a content from at least 20 vol % to at most 70 vol %, such as from at least 25 vol % to at most 65 vol %.

In an embodiment, the body 201 can have a porosity of at most 10 vol %, such as at most 8 vol %, at most 5 vol %, at most 4 vol %, or at most 3 vol % for a total volume of the body. According to another embodiment, the porosity of the abrasive component body can be greater than 0, such as at least 0.001 vol % or at least 0.005 vol % for a total volume of the body. In a further embodiment, the abrasive component body may have a porosity of 0 vol %.

In a further embodiment, the body 201 can include a content of filler of at least 0.1 vol % to 30 vol % for a total volume of the body 201.

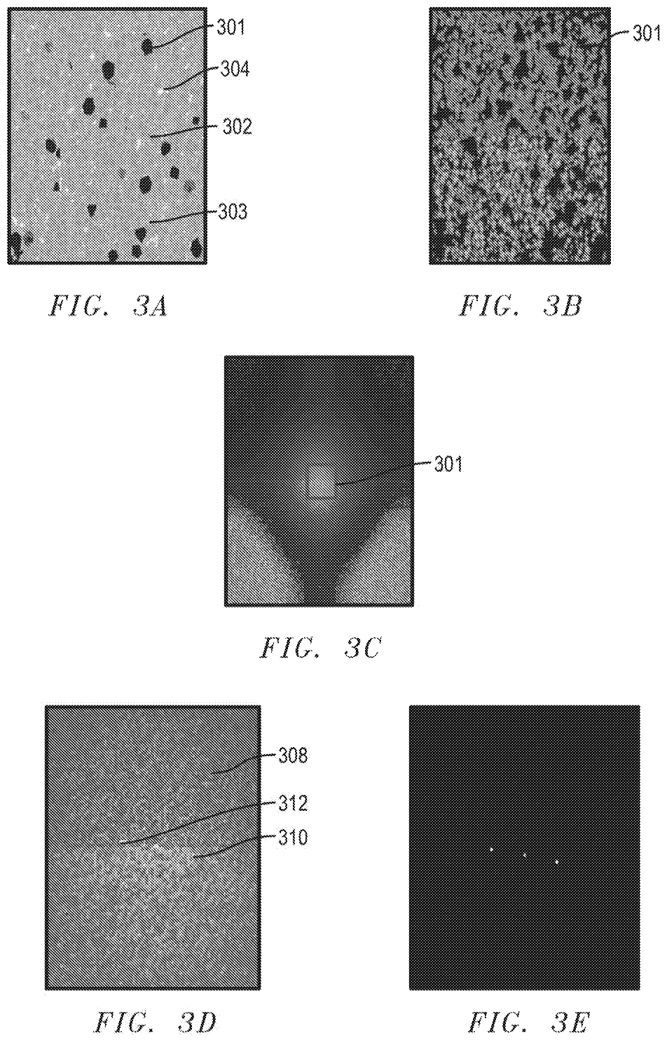

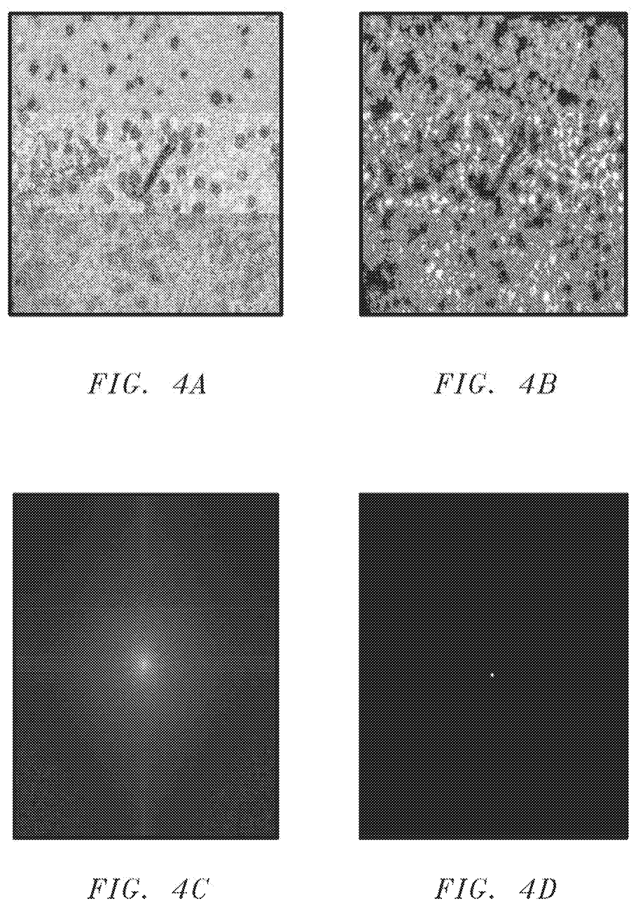

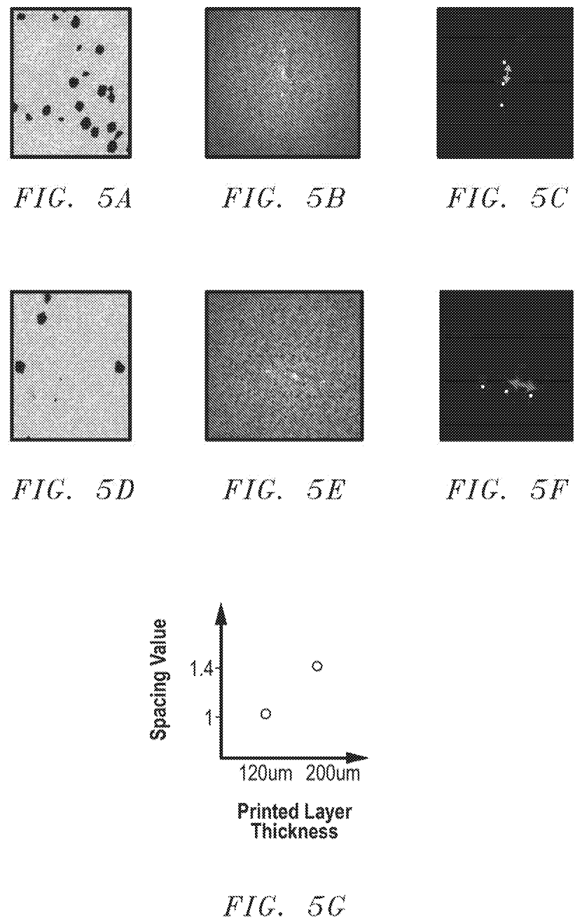

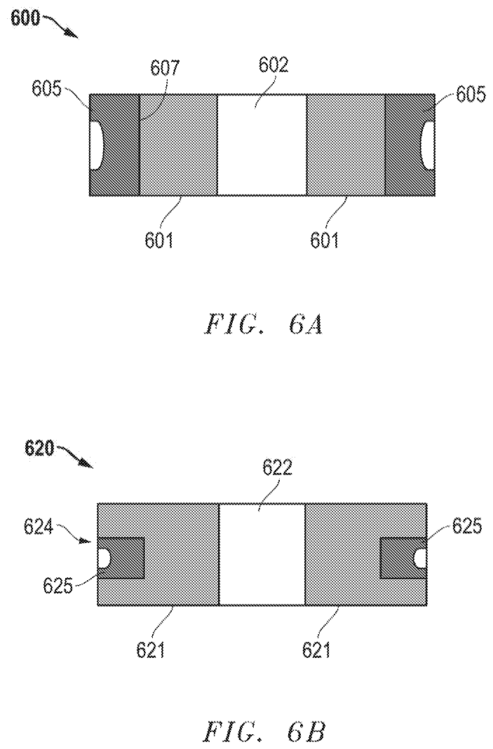

In an embodiment, the body can include a Microstructure Feature. In an aspect, the Microstructure Feature can include a Fast Fourier Transform value, wherein the Fast Fourier Transform value can be greater than 1. In this disclosure, the Fast Fourier Transform value is determined based on frequency domain images transformed from scanning electron microscopic (SEM) images of at least 3 cross sections of the body of a fixed abrasive article. The cross sections can be ground and polished beforehand. The frequency domain images are obtained by utilizing the Fourier Transform through Python to process the SEM images, which will be further described in below paragraphs in view of FIGS. 3A to 3E and FIGS. 4A to 4D.

FIGS. 3A to 3E include images of a cross section of a bonded abrasive body formed in accordance to embodiments described herein. FIG. 3A includes a scanning electron microscopic image of the cross section. As illustrated, the abrasive body can include abrasive particles 301 joined by a bond matrix including a bond material 302 and an infiltrant material 303, and a filler material 304. FIG. 3A can be processed by adjusting the threshold such that only the bond material remains present in the image of FIG. 3B. FIG. 3C includes an image that has been further processed by focusing on the center, the brightest area, of FIG. 3B. FIG. 3D is an image of the magnified area within the box 307 in FIG. 3C. As illustrated in FIG. 3D, noise 308 is in greyscale, and frequency signals 310 and 312 have brightness above the noise. Removing the noise from FIG. 3D, a frequency domain image is generated and illustrated in FIG. 3E. The bright dot in the center is the zero frequency component indicating the average brightness of the image in FIG. 3B, and the other two symmetrically distributed bright dots represent the frequency of the bond material 302. The Fast Fourier Transform value refers to the average number of dots other than the zero frequency components shown in frequency domain images of at least three cross sections. For example, the Fast Fourier Transform value can be determined by dividing the sum of the number of dots that are not the center dot of each frequency domain image by the total number of the frequency domain images.

FIG. 4A includes an SEM image of a bonded abrasive body formed by hot pressing. FIG. 4A was further processed in the same manner as described with respect to FIGS. 3A to 3E to produce FIGS. 4B to 4D. As illustrated in FIG. 4D, only the zero frequency component appears in the frequency domain image, which is to be understood that the hot-press-formed first region includes a Fast Fourier value of 0.

In another aspect, the abrasive body 201 can include a Microstructure Feature including a Fast Fourier Transform value of at least 2. In a further aspect, Fast Fourier Transform value of the abrasive body 201 can be at least 2 or at least 4 or at least 6 or at least 8 or at least 10 or at least 12 or at least 14 or at least 16 or at least 18 or at least 20. In another instance, the abrasive body 201 can include a Fast Fourier Transform value not 15 greater than 40, not greater than 36, not greater than 32, not greater than 30, not greater than 28, not greater than 24, not greater than 20, not greater than 16, not greater than 14, not greater than 12, not greater than 10 or not greater than 9 or not greater than 8 or not greater than 7 or not greater than 6 or not greater than 5 or not greater than 4 or not greater than 3. In another instance, the body 201 can include a Fast Fourier Transform value having a value in a range including any of the minimum and maximum values noted herein.

In a further embodiment, the Microstructure Feature can include a Spacing Value. The abrasive body can include an average distance determined based on frequency domain images (i.e., image of FIG. 3E) of at least three cross sections of the abrasive body. As used herein, the Spacing Value can be determined using the average distance. The average distance is an averaged value of the distance between the zero frequency component (i.e., the center dot) and one other dot of frequency domain images of at least 3 cross sections of the abrasive body. For example, the average distance can be calculated by dividing the total of the distance between the center dot and one other dot of each of the frequency domain images by the number of the distances that makes up the total. The Spacing Value of an abrasive body can be a relative value that can be obtained by dividing the average distance of the abrasive body by the average distance of an abrasive body having layers having the printed thickness of 120 microns.

More particularly, the Spacing Value can be determined as follows.

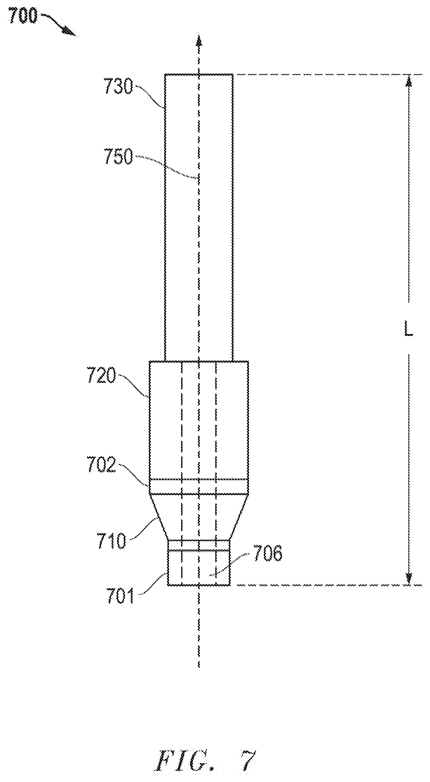

Three SEM images of three cross sections of a bonded abrasive body B1 are taken, and one of the SEM images is illustrated in FIG. 5A. The bonded abrasive body B1 was formed according to embodiments herein and includes layers having the same printed thickness of 120 microns. All the SEM images are processed in accordance with embodiments herein to obtain images illustrated in FIGS. 5B and 5C. As illustrated in the frequency domain image of FIG. 5C, the distance from the center of the center dot to the center of one other dot is measured using Image J for each of the frequency domain image. The average of the 3 distances is calculated and referred to as Da1. The average distance is then divided by itself to have a Spacing Value of the body B1.

Three SEM images of three cross sections of a bonded abrasive body B2 are taken, and one of the SEM images is illustrated in FIG. 5D. The bonded abrasive body B2 was formed according to embodiments herein and includes layers having a printed thickness. All the SEM images are processed as described in embodiments herein to obtain the frequency domain images. Exemplary images are illustrated in FIGS. 5E and 5F. As illustrated in FIG. 5F, the distance from the center of the center dot to the center of one other dot is measured using Image J for each frequency domain image, and the average of all the distances is calculated. The average distance is then divided by Da1 to have the Spacing Value of the body B2.

In an aspect, a distance between the center of the center dot and the center of one other dot may correspond to a certain dimension of a portion of the body 201. For instance, a distance between the center dot and any of the other two dots in FIG. 3E may correspond to a thickness of a portion of the body. FIG. 5G includes a plot of printed layer thickness vs. Spacing Values of bodies B1 and B2. As illustrated, the body B1 can have a Spacing Value of 1, and the body B2 having the printed layer thickness of 200 microns can have a Spacing Value of 1.4.

In an aspect, the body 201 can include a particular Spacing Value that can facilitate improved formation and properties and/or performance of the abrasive article. For example, the Spacing Value can be at least 0.01, such as at least 0.03, or at least 0.04, or at least 0.06, or at least 0.08, or at least 0.1, or at least 0.2, at least 0.3, or at least 0.4, or at least 0.5 or at least 0.6, or at least 0.7, or at least 0.8, or at least 0.9, or at least 1, at least 1.1, or at least 1.3, or at least 1.4, or at least 1.5, or at least 1.6, or at least 1.8, or at least 1.9, or at least 2, or at least 2.1, or at least 2.3, or at least 2.5, or at least 2.6, or at least 2.8, or at least 3, or at least 3.1, or at least 3.3, or at least 3.5, or at least 3.6, or at least 3.8, or at least 4, at least 4.2, or at least 4.5, or at least 4.7, or at least 5, or at least 6, or at least 7, or at least 8, or at least 9, or at least 10, or at least 11, or at least 12, or at least 15, at least 20, at least 30, at least 50, at least 80, at least 100, at least 200, at least 300, at least 400, or at least 500. In another instance, the body 201 may have a Spacing Value of not greater than 2000, or not greater than 1000, or not greater than 500, or not greater than 400, or not greater than 300, or not greater than 200, or not greater than 100, or not greater than 80, or not greater than 50, or not greater than 40, or not greater than 30, or not greater than 20, or not greater than 10, or not greater than 9.8, not greater than 9.6, not greater than 9.5, not greater than 9.3, or not greater than 9, or not greater than 8.8, not greater than 8.6, not greater than 8.4, not greater than 8.2, or not greater than 8, or not greater than 7.8, not greater than 7.6, not greater than 7.4, not greater than 7.2, or not greater than 7, or not greater than 6.8, not greater than 6.6, not greater than 6.4, not greater than 6.2, or not greater than 6, or not greater than 5.8, not greater than 5.6, not greater than 5.5, not greater than 5.2, or not greater than 5, or not greater than 4.8, not greater than 4.6, not greater than 4.4, not greater than 4.2, or not greater than 4, or not greater than 3.8, not greater than 3.6, not greater than 3.4, not greater than 3.2, or not greater than 3, or not greater than 2.8, not greater than 2.6, not greater than 2.4, not greater than 2.2, or not greater than 2, or not greater than 1.8, or not greater than 1.6, or not greater than 1.5, or not greater than 1.4, or not greater than 1.3, or not greater than 1.2, or not greater than 1, or not greater than 0.8, not greater than 0.6, not greater than 0.4, not greater than 0.2, or not greater than 0.1. Moreover, the Spacing Value can be in a range including any of the minimum and maximum values noted herein.

In a further embodiment, the body can include a Defect Value. In an aspect, the Defect Value can include a Non-Bond Value. The Non-Bond Value can be determined by analyzing an SEM image of at least 3 different portions of a cross section of the body. For each image, the area made up by the components that are not the bond matrix is determined and referred to as ANB. The total area made up by all the components is determined and referred to as ATotal. The percentage of ANB for the total area ATotal ([ANB/ATotal)×100%]) of each analyzed image is added up to get the sum and then the sum is divided by the number of the analyzed images to determine the Non-Bond Value of the body. For instance, the Non-Bond Value can be an average percentage of the area made up by the abrasive particles and pores.

In an aspect, the body 201 can include a Non-Bond Value that can facilitate improved formation and improved properties and/or performance of the abrasive articles. For instance, the Non-Bond Value may be not greater than 50%, such as not greater than 40% or not greater than 30% or not greater than 20% or not greater than 15% or not greater than 12% or not greater than 10% or not greater than 9% or not greater than 8% or not greater than 7% or not greater than 6% or not greater than 5% or not greater than 4% or not greater than 3% or not greater than 2%. In another instance, the Non-Bond Value can be at least 0.01% or at least 0.1% or at least 0.5% or at least 1% or at least 2%. Moreover, the Non-Bond Value can be in a range including any of the minimum and maximum percentages noted herein. For example, the Non-Bond Value can be within a range between at least 0.01% and not greater than 50% or within a range between at least 0.1% and not greater than 20% or within a range of between at least 0.5% and not greater than 10%.

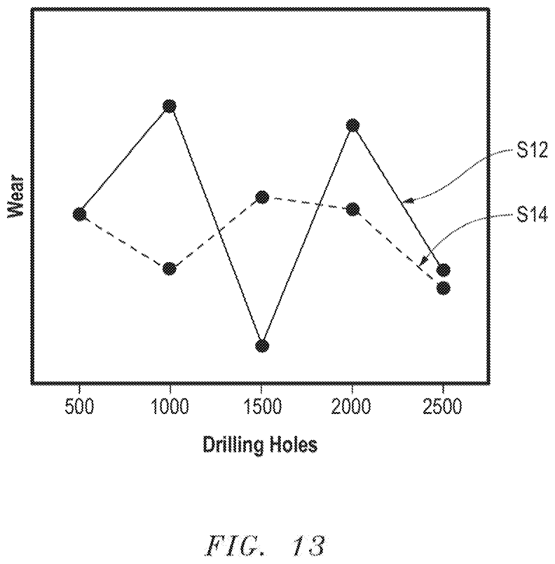

FIG. 11A includes an illustration of a portion of a cross section of a body 1100 including a plurality of layers 1200 including the bond material and abrasive particles and interfaces 1300 between the layers 1200. In an embodiment, the plurality of layers 1200 can be printed layers formed by additive manufacturing, such as binder jetting. In another embodiment, the plurality of layers 1200 can have an orientation relative to a surface of the body, such as the working surface of the body 1201. The working surface is intended to refer to the surface that contacts a workpiece in a material removal operation. For example, for a core drill bit, the top surface of the first region of the abrasive tip can be the working surface. As illustrated, the plurality of layers 1200 can be vertically stacked and each layer can extend in parallel to the working surface 1201, such as in the horizontal direction. FIG. 11B includes a representative frequency domain image of the body 1100. As illustrated, the dots can be vertically aligned.

FIG. 11C includes illustration of a portion of a cross section of a body 1500 including a plurality of layers 1600 including the bond material and abrasive particles and interfaces 1700 between the layers 1600. In a particular embodiment, the layers 1600 can be formed by using a 3D binder jetting printer. As illustrated, the plurality of layers 1600 is slanted relative to the working surface 1601. In an embodiment, the plurality of layers 1600 can be orientated relative to a surface of the body, such as the working surface 1601, at a particular angle that can facilitate improved performance of the abrasive article. In a particular aspect, the layers can be orientated relative to the working surface 1601 of the body at an oblique angle of at least 2°, such as at least 5°, at least 10°, or at least 20°. FIG. 11D includes a representative frequency domain image of the body 1500. As illustrated, the dots are not vertically aligned.

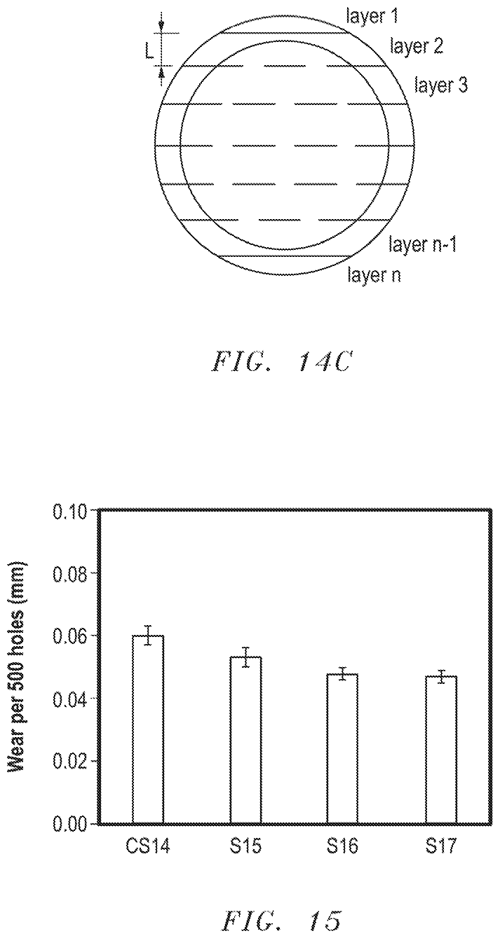

In an embodiment, the body of the abrasive article can include layers oriented at a particular angle that can facilities improved performance of the abrasive article. In an aspect, the body can include layers oriented at an angle, α, relative to the working surface of greater than 0°, such as at least 2°, at least 5°, at least 8°, at least 10°, at least 12°, at least 15°, at least 18°, at least 19°, at least 20°, at least 22°, at least 25°, at least 27°, at least 30°, at least 33°, at least 35°, at least 37°, at least 40°, at least 41°, at least 43°, at least 45°, at least 47°, at least 48°, at least 50°, at least 52°, at least 55°, at least 58°, at least 60°, at least 62°, at least 64°, at least 66°, at least 68°, at least 70°, at least 72°, at least 74°, at least 76°, at least 78°, at least 80°, at least 82°, at least 85°, at least 88°, or at least 90°. Referring to FIG. 14A, a cross section of a portion of the body 1400 of an exemplary core drill bit tip is illustrated, including layers 1402, wherein the layers 1402 form an angle a with respect to the working surface 1401. FIG. 14B includes an illustration of a cross section of a portion of the body 1410 of another exemplary core drill bit tip including layers 1412 forming an angle a with respect to the working surface 1410. It is to be appreciated the angle α is intended to refer to the non-obtuse angle formed between the layers and the working surface of the body. In another aspect, the body can include layers oriented at an angle α relative to the working surface of at most 90°, such as at most 88°, at most 86°, at most 84°, at most 82°, at most 80°, at most 78°, at most 75°, at most 74°, at most 72°, at most 70°, at most 68°, at most 66°, at most 64°, at most 62°, at most 60°, at most 58°, at most 66°, at most 64°, at most 62°, at most 60°, at most 58°, at most 55°, at most 54°, at most 52°, at most 50°, at most 48°, at most 46°, at most 44°, at most 42°, at most 40°, at most 38°, at most 36°, at most 34°, at most 32°, or at most 30°. In a particular aspect, the body can include layers oriented at an angle α in a range including any of the minimum and maximum values noted herein.

The orientation angle α can be determined by formula,

$$α = arc sin ( \frac{L p}{L} ) .$$

Lp is the manufactured thickness of the layers that are formed by additive manufacturing. For instance, the layers can be printed, and accordingly, Lp is the printed thickness of the layers of the abrasive body. Lp is illustrated in FIGS. 14A and 14B. L is the average full thickness of the layers that appear on the working surface of the abrasive article. Referring to FIG. 14C, a working surface of the abrasive body 1410 of FIG. 14B is illustrated, including a plurality of layers. As illustrated, only a portion of Layers 1 and n are present on the working surface. As the thickness of Layers 1 and n shown on the working surface may not be the full thickness, comparing to the other layers, the layer thickness L can be the average thickness of full layers 2 to n−1. As illustrated in FIG. 14C, each of layers 2 to n−1 has the same thickness, and L is the thickness of any one of layers 2 to n−1. Layer thickness L can be measured under a microscope.

In embodiments, manufactured thickness (e.g., printed thickness) may also be determined by using frequency component images of at least 3 cross sections of the abrasive body. For example, the manufactured thickness can be determined by using the Spacing Value of the abrasive body and based on the printed thickness of 120 microns and 200 microns having the Spacing Values of 1 and 1.4, respectively, as noted in embodiments herein.

In an embodiment, the working surface of an abrasive body can include a particular numbers of layers. In an instance, as illustrated, the working surface can include at least 1 layer, at least 2 layers, at least 3 layers, at least 4 layers, at least 5 layers, at least 10 layers, at least 20 layers, at least 30 layers, at least 40 layers, at least 50 layers, at least 60 layers, at least 65 layers, at least 70 layers, at least 80 layers, at least 90 layers, at least 100 layers, at least 200 layers, at least 300 layers, at least 400 layers, at least 500 layers, at least 600 layers, at least 700 layers, at least 800 layers, at least 900 layers, at least 1000 layers, at least 2000 layers, at least 3000 layers, at least 4000 layers, or at least 5000 layers. In another instance, the working surface may include at most 108 layers, at most 107 layers, at most 106 layers, at most 105 layers, or at most 104 layers. It is to be appreciated the number of layers of the working surface of an abrasive body can vary as the manufactured thickness of the layers, the dimension of the working surface, such as the outer diameter, the inner diameter, width, length, and/or perimeter, and/or orientation angles of the layers to suit various applications. In an example, the working surface can include a total number of manufactured layers in a range including any of the minimum and maximum values noted herein. In particular applications, the outer diameter of the first region of the core drill bit tip may be at least 3 mm to at most 125 mm In another particular example, for a core drill bit tip having an outer diameter of 125 mm at the first region and layers having printed thickness of 30 microns at the orientation angle of 90° with respect to the working surface, the working surface can include 4167 layers. In another example, the working surface can include more layers than noted herein as a relatively large working surface can be desired by applications.

In an embodiment, layers including the abrasive particles and bond material, such as 1600 and 1200, can have different wear resistance compared to the interfaces between the layers, such as 1300 and 1700. For instance, the layers including the abrasive particles and bond material can have wear resistance higher than the interfaces.

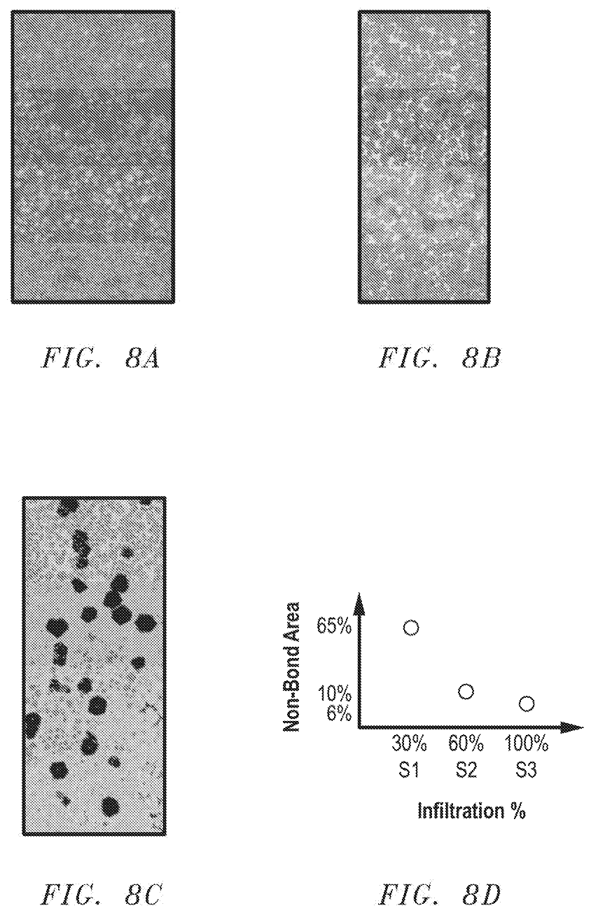

In another embodiment, the abrasive article can include a core, such as a hub, or a shaft, wherein the core can be attached to the body. FIG. 6A includes an illustration of a cross section of a pencil edging wheel 600 including a hub 601 having a central opening 602. The body 605 can be attached to the peripheral surface 607 of the hub 601. The body 605 can have any of the features as described in embodiments herein with respect to the body 201.

FIG. 6B includes an illustration of a cross section of a pencil edging wheel 620 including a hub 621 having a central opening 622 and a peripheral groove 624. As illustrated, the body 625 can be contained within the peripheral groove 624. In another example, the body 625 may be partially contained within the peripheral groove 624.

FIG. 7 includes an illustration of a side view of a core drill bit. The core drill bit can include a shaft 730 attached to a drill body 720 that is connected to an abrasive tip 710. The abrasive tip 710 can include a first region 701 and a second region 702. The first region 701 can have a ring shape and an annular cross-section about the longitudinal axis 750 that extends along and defines a length, L, of the core drill bit 700. The second region 702 can also have an annular cross-section about the longitudinal axis 750. The core drill bit 700 can include a central opening 706 extending in the direction of the longitudinal axis 750 and through the first region 701, the second region 702, and the body 720. The opening 706 may further extend through the shaft 730 (not illustrated) to allow coolant to flow through the drill bit in operations. The abrasive tip 710, the first region 701, and the second region 702 can include any of the features described in embodiments herein with respect to the body 201.

It will be appreciated that the abrasive articles of the embodiments herein can have a body that may be in the form of a hone, a cone, a cup, flanged shapes, a cylinder, a wheel, a ring, and a combination thereof. In a particular instance, the body can include at least one surface having an arcuate contour.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

### EMBODIMENTS

Embodiment 1. An abrasive article comprising:
a body including:
abrasive particles contained in a bond matrix;
a Microstructure Feature of greater than 1; and
a Non-Bond Value of not greater than 50%.

Embodiment 2. An abrasive article, comprising:
a body including:
abrasive particles contained in a bond matrix;
a Microstructure Feature comprising a Spacing Value of at least 0.01.

Embodiment 3. The abrasive article of embodiment 1 or 2, wherein the body comprises a Microstructure Feature of at least 2 or at least 3 or at least 4 or at least 5 or at least 6 or at least 7.

Embodiment 4. The abrasive article of embodiment 1 or 2, wherein the body comprises a Microstructure Feature not greater than 10 or not greater than 9 or not greater than 8 or not greater than 7 or not greater than 6 or not greater than 5 or not greater than 4 or not greater than 3.

Embodiment 5. The abrasive article of embodiment 1 or 2, wherein the Microstructure Feature comprises a Spacing Value of at least 0.01, or at least 0.03, or at least 0.04, or at least 0.06, or at least 0.08, or at least 0.1, or at least 0.2, at least 0.3, or at least 0.4, or at least 0.5 or at least 0.6, or at least 0.7, or at least 0.8, or at least 0.9, or at least 1, at least 1.1, or at least 1.3, or at least 1.4, or at least 1.5, or at least 1.6, or at least 1.8, or at least 1.9, or at least 2, or at least 2.1, or at least 2.3, or at least 2.5, or at least 2.6, or at least 2.8, or at least 3, or at least 3.1, or at least 3.3, or at least 3.5, or at least 3.6, or at least 3.8, or at least 4, at least 4.2, or at least 4.5, or at least 4.7,or at least 5, or at least 6, or at least 7, or at least 8, or at least 9, or at least 10, or at least 11, or at least 12, or at least 15, at least 20, at least 30, at least 50, at least 80, at least 100, at least 200, at least 300, at least 400, or at least 500.

Embodiment 6. The abrasive article of embodiment 1, wherein the Microstructure Feature comprises a Spacing Value of not greater than 2000, or not greater than 1000, or not greater than 500, or not greater than 400, or not greater than 300, or not greater than 200, or not greater than 100, or not greater than 80, or not greater than 50, or not greater than 40, or not greater than 30, or not greater than 20, or not greater than 10, or not greater than 9.8, not greater than 9.6, not greater than 9.5, not greater than 9.3, or not greater than 9, or not greater than 8.8, not greater than 8.6, not greater than 8.4, not greater than 8.2, or not greater than 8, or not greater than 7.8, not greater than 7.6, not greater than 7.4, not greater than 7.2, or not greater than 7, or not greater than 6.8, not greater than 6.6, not greater than 6.4, not greater than 6.2, or not greater than 6, or not greater than 5.8, not greater than 5.6, not greater than 5.5, not greater than 5.2, or not greater than 5, or not greater than 4.8, not greater than 4.6, not greater than 4.4, not greater than 4.2, or not greater than 4, or not greater than 3.8, not greater than 3.6, not greater than 3.4, not greater than 3.2, or not greater than 3, or not greater than 2.8, not greater than 2.6, not greater than 2.4, not greater than 2.2, or not greater than 2, or not greater than 1.8, or not greater than 1.6, or not greater than 1.5, or not greater than 1.4, or not greater than 1.3, or not greater than 1.2, or not greater than 1, or not greater than 0.8, not greater than 0.6, not greater than 0.4, not greater than 0.2, or not greater than 0.1.

Embodiment 7. The abrasive article of embodiment 1 or 2, wherein the body comprises a Non-Bond Value not greater than 50% or not greater than 40% or not greater than 30% or not greater than 20% or not greater than 15% or not greater than 12% or not greater than 10% or not greater than 9% or not greater than 8% or not greater than 7% or not greater than 6% or not greater than 5% or not greater than 4% or not greater than 3% or not greater than 2%.

Embodiment 8. The abrasive article of embodiment 1 or 2, wherein the Non-Bond Value is at least 0.01% or at least 0.1% or at least 0.5% or at least 1% or at least 2%.

Embodiment 9. The abrasive article of embodiment 1 or 2, wherein the Non-Bond Value is within a range between at least 0.01% and not greater than 50% or within a range between at least 0.1% and not greater than 20% or within a range of between at least 0.5% and not greater than 10%.

Embodiment 10. The abrasive article of embodiment 1 or 2, wherein the bond matrix comprises a first phase and a second phase.

Embodiment 11. The abrasive article of embodiment 10, wherein the first phase comprises a metal. 20 Embodiment 12. The abrasive article of embodiment 11, wherein the first phase comprises a metal including at least one of a transition metal element, a Group 2 element, a Group 13 element, a Group 14 element, a Group 15 element, or any combination thereof.

Embodiment 13. The abrasive article of embodiment 9, wherein the second phase comprises a metal.

Embodiment 14. The abrasive article of embodiment 13, wherein the second phase comprises a metal including at least one of a transition metal element, a Group 2 element, a Group 13 element, a Group 14 element, a Group 15 element, or any combination thereof.

Embodiment 15. The abrasive article of embodiment 13, wherein the second phase comprises a metal including at least one of copper, tin, iron, chromium, tungsten, molybdenum, vanadium, silver, titanium, magnesium, cobalt, nickel, zinc, or any combination thereof.

Embodiment 16. The abrasive article of embodiment 10, wherein the first phase defines an interconnected phase extending through at least a majority of the volume of the body.

Embodiment 17. The abrasive article of embodiment 10, wherein the second phase defines an interconnected phase extending through at least a majority of the volume of the body.

Embodiment 18. The abrasive article of embodiment 10, wherein the first phase defines a matrix phase and the second phase defines an infiltrant phase.

Embodiment 19. The abrasive article of embodiment 10, wherein the body includes:
a content of the first phase of at least 20 vol % and not greater than 70 vol % for a total volume of the body;
a content of the second phase of at least 20 vol % and not greater than 80 vol % for a total volume of the body; or
a combination thereof.

Embodiment 20. The abrasive article of embodiment 1 or 2, wherein the body includes a content of the bond material of at least 20 vol % and not greater than 70 vol % for a total volume of the body.

Embodiment 21. The abrasive article of embodiment 1 or 2, wherein the abrasive particles comprise a material selected from the group consisting of oxides, carbides, nitrides, borides, diamond, or any combination thereof.

Embodiment 22. The abrasive article of embodiment 1 or 2, wherein the abrasive particles consist essentially of one or more superabrasive material.

Embodiment 23. The abrasive article of embodiment 1 or 2, wherein the abrasive particles consist essentially of diamond.

Embodiment 24. The abrasive article of embodiment 1 or 2, wherein the body includes a content of the abrasive particles of at least 1 vol % and not greater than 40 vol % for a total volume of the body.

Embodiment 25. The abrasive article of embodiment 1 or 2, wherein the abrasive particles have an average particle size of at least 25 microns and not greater than 400 microns.

Embodiment 26. The abrasive article of embodiment 1 or 2, wherein the body includes a content of porosity of at least 0.0001 vol % and less than 10 vol % for a total volume of the body.

Embodiment 27. The abrasive article of embodiment 1, further comprising a hub attached to the body, wherein the hub comprises a central opening and wherein the body is attached to at least one surface of the hub.

Embodiment 28. The abrasive article of embodiment 1 or 2, wherein a majority of the abrasive particles are contained within the bond material and form a bonded abrasive body.

Embodiment 29. The abrasive article of embodiment 1 or 2, wherein a majority of the abrasive particles are present as a single layer in a layer of bond material.

Embodiment 30. The abrasive article of embodiment 27, wherein the body is attached to a peripheral surface of the hub.

Embodiment 31. The abrasive article of embodiment 30, wherein the hub comprises a peripheral groove and the body is contained at least partially within the peripheral groove.

Embodiment 32. The abrasive article of embodiment 31, wherein the body comprises at least one surface having an arcuate contour.

Embodiment 33. A method for forming an abrasive article comprising:
forming a green body via additive manufacturing: wherein the body includes:
a bond precursor material; and
abrasive particles contained within the bond precursor material;
treating the green body to form an abrasive article, wherein treating includes infiltrating, and wherein the abrasive article comprises a body having a Non-bond Value of not greater than 50 vol %

Embodiment 34. The method of embodiment 33, wherein forming includes:
forming a first layer including the bond precursor material, abrasive particles, and a binder; and
forming a second layer overlying at least a portion of the first layer, wherein the second layer includes the bond precursor material, abrasive particles, and the binder.

Embodiment 35. The method of embodiment 33, wherein forming includes:
binding a first layer of material with a binder, wherein the first layer includes the bond precursor material, abrasive particles, and a binder; and
binding a second layer overlying at least a portion of the first layer, wherein the second layer includes the bond precursor material, abrasive particles, and the binder.

Embodiment 36. The method of embodiment 35, wherein binding the first layer includes depositing a binder in a powder bed.

Embodiment 37. The method of embodiment 36, wherein the powder bed includes the bond precursor material.

Embodiment 38. The method of embodiment 36, wherein the powder bed includes the abrasive particles.

Embodiment 39. The method of embodiment 36, further comprising depositing the abrasive particles in the powder bed prior to a deposition of the binder.

Embodiment 40. The method of embodiment 39, wherein depositing the abrasive particles includes a controlled deposition process including control of at least one parameter selected from the group of position of the abrasive particle, size of the abrasive particle, shape of the abrasive particle, composition of the abrasive particle, orientation of the abrasive particle or any combination thereof.

Embodiment 41. The method of embodiment 36, wherein binding the first layer includes selective deposition of the binder on the powder bed to bind the component materials in contact with the binder.

Embodiment 42. The method of embodiment 35, wherein binding the second layer includes depositing a binder in a powder bed.

Embodiment 43. The method of embodiment 42, wherein the powder bed includes the bond precursor material.

Embodiment 44. The method of embodiment 42, wherein the powder bed includes the abrasive particles.

Embodiment 45. The method of embodiment 42, further comprising depositing the abrasive particles in the powder bed prior to a deposition of the binder.

Embodiment 46. The method of embodiment 45, wherein depositing the abrasive particles includes a controlled deposition process including control of at least one parameter selected from the group of position of the abrasive particle, size of the abrasive particle, shape of the abrasive particle, composition of the abrasive particle, orientation of the abrasive particle or any combination thereof.

Embodiment 47. The method of embodiment 42, wherein binding the first layer includes selective deposition of the binder on the powder bed to bind the component materials in contact with the binder.

Embodiment 48. The method of embodiment 33, wherein forming includes:
selectively binding portions of a plurality of layers to form a green body, wherein the green body is contained in a bed of unbound powder; and
removing the unbound powder and extracting the green body.

Embodiment 49. The method of embodiment 48, wherein selectively binding includes at least one process from the group of selective deposition of a binder, curing, heating, irradiating, drying, or any combination thereof.

Embodiment 50. The method of embodiment 48, wherein selectively binding includes:
a) forming a first layer of unbound powder including the bond precursor material and abrasive particles;
b) selectively depositing a binder in portions of the first layer, wherein after selectively depositing the binder, the first layer includes unbound regions and bound regions, wherein the bound regions include the binder;
c) forming a second layer of unbound powder overlying the first layer, wherein the second layer includes the bond precursor material and abrasive particles; and
d) selectively depositing a binder in portions of the second layer, wherein after selectively depositing the binder, the second layer includes unbound regions and bound regions, wherein the bound regions include the binder.

Embodiment 51. The method of any one of embodiments 33 and 48, further comprising infiltrating the green body with an infiltrant comprising metal after forming the green body.

Embodiment 52. The method of embodiment 51, further comprising conducting at least one treatment process prior to infiltrating the green body, wherein the at least one treatment process is selected from the group of heating, drying, volatilizing, cooling, freezing, or any combination thereof.

Embodiment 53. The method of embodiment 51, wherein infiltrating the green body is conducted simultaneously with sintering of the green body and transforming the bond precursor material to a bond material.

Embodiment 54. The method of embodiment 51, wherein infiltrating is conducted in a non-oxidizing atmosphere.

Embodiment 55. The method of embodiment 51, wherein infiltrating is conducted at a temperature of at least 600° C. and not greater than 1320° C.

Embodiment 56. The method of embodiment 51, wherein infiltrating is conducted for a duration of at least 5 minutes and not greater than 24 hours.

Embodiment 57. The method of embodiment 51, wherein the abrasive article includes a bond material including a first phase associated with the bond precursor material and a second phase associated with an infiltrant that infiltrates the porosity of the green body during infiltration.

Embodiment 58. The method of embodiment 57, wherein the bond precursor material comprises a metal.

Embodiment 59. The method of embodiment 58, wherein the bond precursor material comprises a metal including at least one of a transition metal element, a Group 2 element, a Group 13 element, a Group 14 element, a Group 15 element, or any combination thereof.

Embodiment 60. The method of embodiment 57, wherein the infiltrant comprises a metal.

Embodiment 61. The method of embodiment 60, wherein the infiltrant comprises a metal including at least one of a transition metal element, a Group 2 element, a Group 13 element, a Group 14 element, a Group 15 element, or any combination thereof.

Embodiment 62. The method of embodiment 60, wherein the infiltrant comprises a metal including at least one of copper, tin, iron, chromium, tungsten, molybdenum, vanadium, silver, titanium, magnesium, cobalt, nickel, zinc, or any combination thereof.

Embodiment 63. The abrasive article of embodiment 9, wherein the first phase defines an interconnected phase extending through at least a majority of the volume of the body.

Embodiment 64. The abrasive article of embodiment 9, wherein the second phase defines an interconnected phase extending through at least a majority of the volume of the body.

Embodiment 65. The method of embodiment 51, wherein the abrasive particles comprise a material selected from the group consisting of oxides, carbides, nitrides, borides, diamond, or any combination thereof.

Embodiment 66. The method of embodiment 51, wherein the abrasive particles consist essentially of diamond.

Embodiment 67. The method of embodiment 51, wherein the green body includes a content of porosity of at least 30 vol % and not greater than 60 vol % for a total volume of the green body.

Embodiment 68. The method of embodiment 51, wherein the abrasive article comprises a body, and wherein the body includes a content of porosity of not greater than 8 vol % for a total volume of the body.

Embodiment 69. The method of embodiment 51, wherein further comprising attaching the body to a hub, wherein the hub comprises a central opening and wherein the body is attached to at least one surface of the hub.

Embodiment 70. The method of embodiment 69, wherein the hub comprises a peripheral groove and the body is contained at least partially within the peripheral groove.

Embodiment 71. The method of embodiment 33, wherein the body comprises a Microstructure Feature of greater than 1.

### EXAMPLES

### Example 1

Green bodies were formed having a bond material of an iron-based alloy and diamond abrasive particles, utilizing an ExOne binder jetting 3D printer, in accordance with embodiments described herein. The green bodies were infiltrated with bronze under different infiltrating conditions to form Samples S1, S2, and S3. The infiltrating conditions for forming the samples were different by at least one variable including infiltrating temperature, duration, manner of applying the infiltrant, type of furnace, another variable, or any combination thereof.

FIGS. 8A to 8C include SEM images of cross sections of Samples S1 to S3, respectively. Effective infiltration of each Sample was determined by analyzing the images and calculating the content of the infiltrant present in Samples S1 to S3, respectively. Sample S1 had an effective infiltration of 30%, Sample S2 had an effective infiltration of 60%, and Sample S3 had an effective infiltration of 100%. FIG. 7D includes a plot of effective infiltration vs. Non-Bond Value of the Samples. The Non-Bond Value is the percentage of the area made up by diamond particles and pores. Sample S1 had a Non-Bond Value of approximately 65%, S2 had a Non-Bond Value of approximately 10%, and S3 had a Non-Bond Value of approximately 6%.

### Example 2

Core drill bit Samples S4 and S5 and pencil edge wheels S6 and S7 were formed. Green bodies of Samples S4 to S6 were using an ExOne binder jetting 3D printer as described in embodiments herein. The SS420 bond material and diamond abrasive particles were used to form Samples S4 and S6. Samples S5 and S7 were formed using the HSSM2 bond material and diamond abrasive particles. Compositions of the bond materials HSSM2 and SS42 are included in Table 1 and Table 2 below, respectively.

TABLE 1

| HSSM2 Composition | (wt %) |
|---|---|
| Fe | Balance |
| C | 0.85 |
| Cr | 4.14 |
| Mn | 0.32 |
| Si | 0.39 |
| V | 1.82 |
| W | 6.34 |
| Mo | 5.1 |

TABLE 2

| SS420 Composition | (wt %) |
|---|---|
| Fe | Balance |
| C | <0.15% |
| Cr | 12.0-14.0% |
| Mn | <1.0% |
| Si | <1.0% |
| P | <0.04% |
| S | <0.03% |

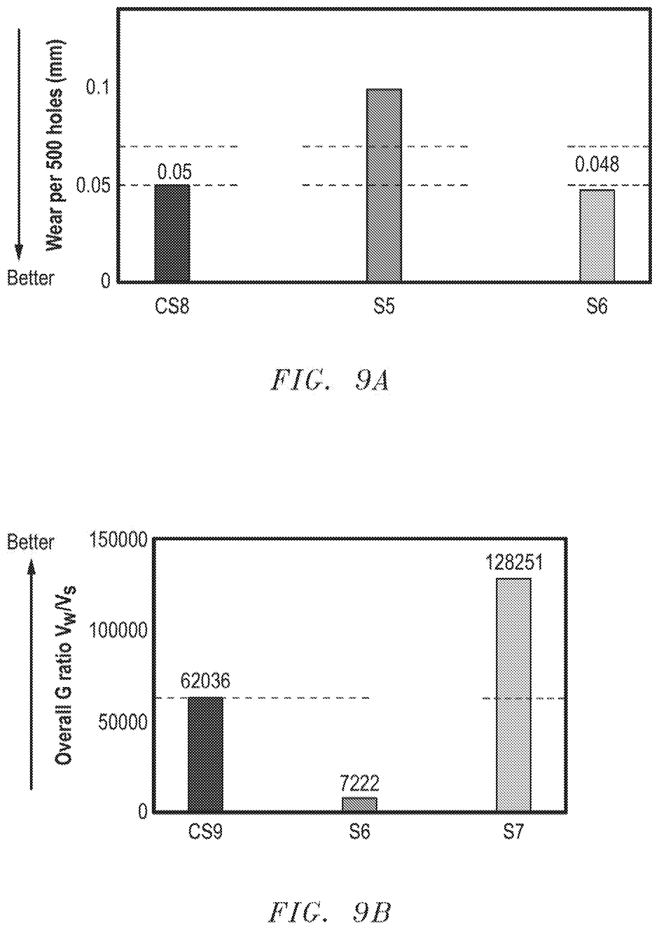

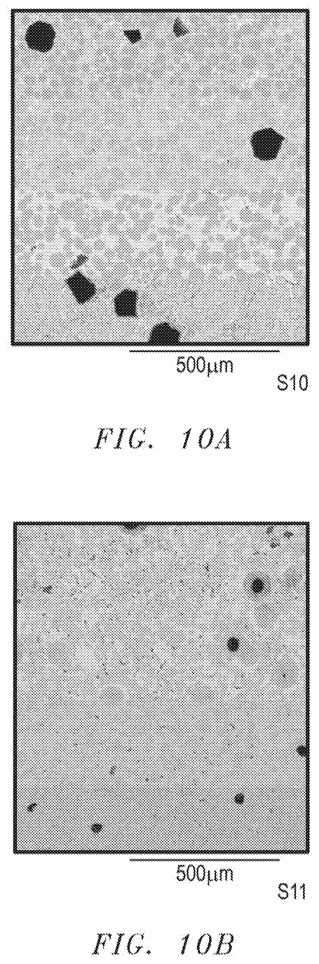

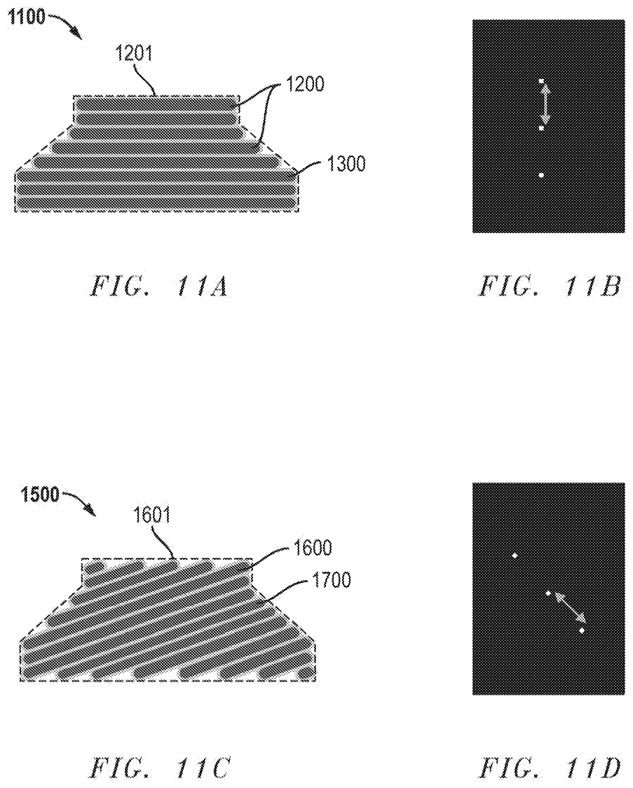

All green bodies were infiltrated with bronze to have a Non-Bond Value not greater than 10%. Wear of Samples S5 and S6 were tested by drilling 500 holes in a piece of glass. Wear is the reduction in the length of the abrasive tips of the core drill bit Samples after completion of drilling 500 holes compared to the original length. FIG. 9A includes an illustration of wear of Samples S5, S6, and Sample CS8 that is representative of the state of the art and commercially available from Saint-Gobain Abrasives. As illustrated, Sample S6 demonstrated similar wear as CS8. Sample S5 had higher wear compared to S6 and CS8.

G-Ratio of Samples S6 and S7 and a pencil edge wheel (Sample CS9) that is representative of the state of the art and commercially available from Saint-Gobain Abrasives were tested by profiling edges of glass pieces. As illustrated in FIG. 9B, Sample S7 demonstrated improved G-Ratio over Sample CS9 and S6.

### Example 3

Core drill bit Samples S10 and S11 were formed. Green bodies of the Samples were formed with the same iron-based stainless steel bond material and diamond abrasive particles using an ExOne binder jetting 3D printer as described in embodiments herein. The green bodies were infiltrated with bronze under different infiltrating conditions for forming Samples S10 and S11.

A green body was infiltrated according to embodiments herein to form the bonded body of Sample S10.

Another green body was immersed in bronze and placed in a furnace and heated under a nitrogen atmosphere with the protocol below to form bonded body of Sample S11: vacuum was applied in a furnace for 10 min at 23° C., after which the furnace was filled with nitrogen. Then the vacuum was applied again for 10 min at 23° C., and the furnace was filled with nitrogen and temperature was ramped at 5° C./min to 500° C. and held for 60 min, then ramped at 2° C./min to 600° C. and held for 90 min, after that, the temperature was ramped at 2.5 ° C./min to 1000° C. and held for 1 min, then ramped at 2° C./min to 1120° C. and held for 90 min. The furnace then was allowed to cool down to 23° C. The bonded abrasive body of Sample S11 was removed from the furnace.

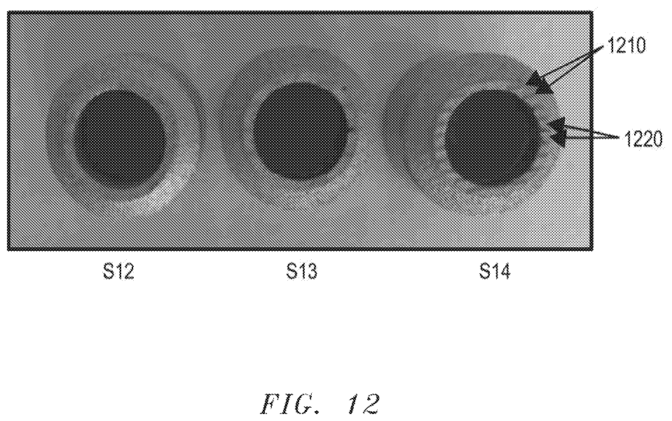

FIGS. 10A and 10B include a SEM image of a cross section of bonded abrasive bodies of Samples S10 and S11, respectively. Each of the bonded bodies was attached to a shaft to from Samples S11 and S12, respectively. Both Samples were subjected to a glass drilling test using the same glass work pieces under the same conditions. Sample S10 had a wear of 0.1 mm after drilling 500 holes, while Sample S11 was not able to drill and caused the work piece to break.

### Example 4

Core drill bit samples were formed. Green bodies were formed using a 3D binder jetting printer and infiltrated according to embodiments herein. Sample S12 was formed including layers printed horizontally. S13 were formed including printed layers that are orientated at the angle of 5° with respect to the horizontal direction. S14 was formed including printed layers orientated at the angle of 10° with respect to the horizontal direction.

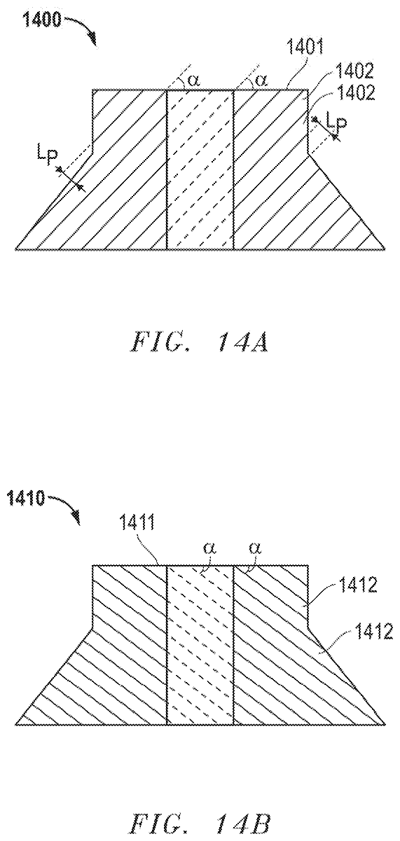

Photos of Samples 12 to 14 are included in FIG. 12. Printed layers 1220 and interfaces 1210 on the working surfaces of the samples can be observed. Sample S13 has 6 printed layers on the working surface, and Sample S14 has 10 printed layers on the working surface. FIG. 13 includes a plot of number of drilled holes vs. wear of Samples S12 and S14.

### Example 5

Additional core drill bit were formed according to embodiments herein. Samples CS14 were formed including layers printed horizontally. Samples S15 to S17 were formed having layers printed at an orientation angle of 5°, 10°, and 30°, respectively. All the samples were formed having the printed layer thickness of 200 microns. Wear rates of the core drill bits samples were tested by drilling 500 holes in glass workpieces. FIG. 15 includes a graph illustrating average wear rates per 500 drilled holes. Each data point is an average of the test results of 3 samples, and each sample was tested for drilling 500 holes for 4 to 5 times. Samples S15 demonstrated up to 11% of decrease of wear rates compared to Samples CS14. Wear rates of Samples S16 and S17 reduced approximately 20% compared Samples CS14.

### Example 6

Core drill bits samples are formed in a similar manner to Example 5. Sample S18 including layers printed horizontally. Samples S19 to S28 include layers printed at an orientation angle of 5°, 10°, 30°, 60°, 70°, 80°, and 90°, respectively. All the samples are subjected to in a drilling test. Wear rates of the samples are determined.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Reference herein to a material including one or more components may be interpreted to include at least one embodiment wherein the material consists essentially of the one or more components identified. The term “consisting essentially” will be interpreted to include a composition including those materials identified and excluding all other materials except in minority contents (e.g., impurity contents), which do not significantly alter the properties of the material. Additionally, or in the alternative, in certain non-limiting embodiments, any of the compositions identified herein may be essentially free of materials that are not expressly disclosed. The embodiments herein include range of contents for certain components within a material, and it will be appreciated that the contents of the components within a given material total 100%.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

1. An abrasive article comprising:
a body including:
abrasive particles contained in a bond matrix;
a Fast Fourier Transform value of greater than 1; and
at least one of a Non-Bond Value of not greater than 50% and a Spacing Value of at least 0.01.

2. The abrasive article of claim 1, wherein the body comprises a Non-Bond Value of at last 0.01% and not greater than 15%.

3. The abrasive article of claim 1, wherein the bond matrix comprises a first phase comprising a bond material and a second phase defining an infiltrant phase.

4. The abrasive article of claim 3, wherein the bond material comprises the metal including tungsten, vanadium, molybdenum, or a combination thereof.

5. The abrasive article of claim 3, wherein the bond material comprises an iron-based material.

6. The abrasive article of claim 5, wherein the bond material comprises:
at least 1 wt % to at most 15 wt % of molybdenum for a total weight of the bond material;
at least 0.5 wt % to at most 10 wt % of vanadium for the total weight of the bond material;
at least 1 wt % and at most 11 wt % of chromium for the total weight of the bond material;
at least 1 wt % and at most 20 wt % of tungsten for the total weight of the bond material; or
any combination thereof.

7. The abrasive article of claim 3, wherein the body includes:
a content of the first phase of at least 20 vol % and not greater than 70 vol % for a total volume of the body;
a content of the second phase of at least 20 vol % and not greater than 80 vol % for a total volume of the body; or
a combination thereof.

8. The abrasive article of claim 1 wherein the body comprises at least one layer including abrasive particles and at least a portion of the bond matrix, wherein the at least one layer is oriented at an angle relative to a working surface of the body.

9. The abrasive article of claim 8, wherein the body comprises a plurality of layers including the at least one layer, where the plurality of layers are oriented at the angle greater than 0° and at most 90°.

10. The abrasive article of claim 9, wherein the plurality of layers are oriented at the angle of at least 5°.

11. The abrasive article of claim 1, wherein the body includes a content of porosity of at least 0.0001 vol % and less than 10 vol % for a total volume of the body.

12. The abrasive article of claim 1, further comprising a hub attached to the body, wherein the hub comprises a central opening and wherein the body is attached to at least one surface of the hub.

13. The abrasive article of claim 12, wherein the hub comprises a peripheral groove and the body is contained at least partially within the peripheral groove.

14. The abrasive article of claim 9, wherein the body comprises at least one surface having an arcuate contour.

15. A method for forming an abrasive article comprising:
forming a green body via additive manufacturing, wherein the body includes:
a bond precursor material; and
abrasive particles contained within the bond precursor material;
treating the green body to form an abrasive article, wherein treating includes infiltrating, and wherein the abrasive article comprises a body having a Non-bond Value of not greater than 50%.

16. An abrasive article, comprising:
a body including:
abrasive particles contained in a bond matrix;
a Fast Fourier Transform value of greater than 1; and
at least one of a Non-Bond Value of not greater than 50% and a Spacing Value of at least 0.01,
wherein the body comprises a plurality of layers including the abrasive particles and bond material, where the plurality of layers are oriented at the angle greater than 0° and at most 90° relative to a working surface of the body.

17. The abrasive article of claim 16, wherein the plurality of layers are oriented at the angle of at least 5°

18. The abrasive article of claim 16, wherein the bond material comprises the metal including tungsten, vanadium, molybdenum, or a combination thereof.

19. The abrasive article of claim 16, wherein the bond material comprises an iron-based material.

20. The abrasive article of claim 16, wherein the bond material comprises:
at least 1 wt % to at most 15 wt % of molybdenum for a total weight of the bond material;
at least 0.5 wt % to at most 10 wt % of vanadium for the total weight of the bond material;
at least 1 wt % and at most 11 wt % of chromium for the total weight of the bond material; or
at least 1 wt % and at most 20 wt % of tungsten for the total weight of the bond material.
